(19) United States
(12) Patent Application Publication
(10) Pub. No.: US 2004/0229089 A1
(43) Pub. Date: Nov. 18, 2004

(54) Method for operating a fuel cell system, and associated fuel cell system

(75) Inventors: Walter Preidel, Erlangen (DE); Walter Stuhler, Hirschaid (DE); Alfred Weiss, Forchheim (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 10/868,701

(22) Filed: Jun. 14, 2004

Related U.S. Application Data
(63) Continuation of application No. PCT/DE02/04556, filed on Dec. 12, 2002.

(30) Foreign Application Priority Data
Dec. 14, 2001 (DE) 101 61 623.6

(51) Int. Cl. H01M 8/04; H01M 8/10; H01M 8/12

(52) U.S. Cl. 429/13; 429/26; 429/25; 429/30

(57) ABSTRACT

A method for operating a fuel cell system which uses a combustion gas and an oxidant, must take care to ensure sufficient humidification of the combustion gas by evaporating humidifying water. The energy source for the evaporation of the combustion gas and/or oxidant is the heat generated by the coil temperature of an electric motor used to transport the gas.

### CROSS-REFERENCE TO RELATED APPLICATION

This application is a continuation, under 35 U.S.C. § 120, of copending international application No. PCT/DE02/04556, filed Dec. 12, 2002, which designated the United States; this application also claims the priority, under 35 U.S.C. § 119, of German patent application No. 101 61 623.6, filed Dec. 14, 2001; the prior applications are herewith incorporated by reference in their entirety.

### BACKGROUND OF THE INVENTION

Field of the Invention

The invention relates to a method for operating a fuel cell system with a fuel gas and an oxidizing agent, in which it is ensured that the fuel gas and/or the oxidizing agent is/are sufficiently humidified, for which purpose humidification water is evaporated. In addition, the invention also relates to an associated fuel cell system having at least one fuel cell module that is operated with a fuel gas and an oxidizing agent.

In particular, what are known as air polymer electrolyte membrane (PEM) fuel cells, operated with hydrogen and air, including their method program and the associated functioning are already known in detail from the prior art. The same is true of solid oxide fuel cells (SOFC) that are operated with different fuel gases at high temperatures. In both cases, the oxidizing agent used is advantageously oxygen from the ambient air, and consequently a sufficient quantity of atmospheric oxygen has to be provided for fuel cell operation. For this purpose, it is customary to compress ambient air; suitable compressors are known for this purpose.

In particular, in the case of PEM fuel cells supplied with air, a sufficient supply of air is important for stable operation that is insensitive to rapid load changes. The supply of air also ensures sufficient humidification of the air in accordance with its respective dew point, with the dew point approximately corresponding to the cooling water outlet temperature or a higher value at the respective pressures and temperatures of the fuel cell module. This is important in particular if the cooling of the fuel cell module is not optimum.

In the prior art, the energy required to evaporate the water that is used to humidify the air has to be imparted to the water by a sufficient increase in temperature before the water is injected into the compressor. On account of the extremely high evaporation enthalpy of water, this cannot be achieved to a sufficient degree purely by increasing the temperature, for example to 60° C. Alternatively, it would be possible to increase the quantity of water to such an extent that as a result of a drastic excess of water, at, for example 60° C., the required quantity of water would nevertheless be evaporated to a sufficient extent.

The latter principle is realized in what is known as a liquid ring compressor. However, if a screw-type compressor is used as a technical alternative, it is not possible to inject so much water that a sufficient quantity of water is evaporated.

### SUMMARY OF THE INVENTION

It is accordingly an object of the invention to provide a method for operating a fuel cell system that overcomes the above-mentioned disadvantages of the prior art devices of this general type.

With the foregoing and other objects in view there is provided, in accordance with the invention, a method for operating a fuel cell system with a fuel gas and an oxidizing agent. The method includes the steps of sufficiently humidifying the fuel gas and/or the oxidizing agent by evaporating humidification water, and utilizing heat generated by a winding temperature of an electric motor used to deliver gases as an energy source for evaporating the humidification water to humidify the fuel gas and/or the oxidizing agent.

The invention makes use of the fact that the water, before it is injected into the compressor, is used to cool the motor of the compressor, and the winding of the motor is constructed in such a manner that the winding temperature, by using suitable insulation, for example a Teflon insulation, can reach temperatures higher than 100° C. As a result, the uptake of heat by the water, if the pressure in the cooling-water line is selected appropriately, is sufficient to take up the evaporation enthalpy for sufficient humidification of gases.

Therefore, additional cooling of the compressor can also be effected.

The principle of the invention of utilizing the motor waste heat to evaporate water is advantageously also possible with other motors. For example, if it is used in a vehicle, the method can also be applied in particular to the traction motor. Motors for pumps or the like can also be utilized in accordance with the invention.

In the fuel cell system according to the invention, the compressor is assigned an electric motor that contains a device for cooling using cooling water, with the cooling water that emerges being fed to the compressor as humidification water. In this case, the cooling-water line may advantageously be a copper tube and can be used directly as coil material for the motor winding. The coil may also have alternating windings of solid material and tube material.

The invention therefore allows the motor heat to be transferred to the cooling water, so that the process gases are humidified. In particular, the humidification of the oxidizing-agent compressor air is simplified for fuel cell operation. The result is a considerable improvement to efficiency. The fuel gas can also be humidified in the same way.

Other features which are considered as characteristic for the invention are set forth in the appended claims.

Although the invention is illustrated and described herein as embodied in a method for operating a fuel cell system, and an associated fuel cell system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic illustration of a fuel cell module which is operated with hydrogen as the fuel gas and compressed ambient air as the oxidizing agent; and

FIG. 2 is a fluid circuit diagram for an air compressor for a fuel cell module in accordance with FIG. 1 with an associated electric motor.

### DESCRIPTION OF THE PREFERRED EMBODIMENTS

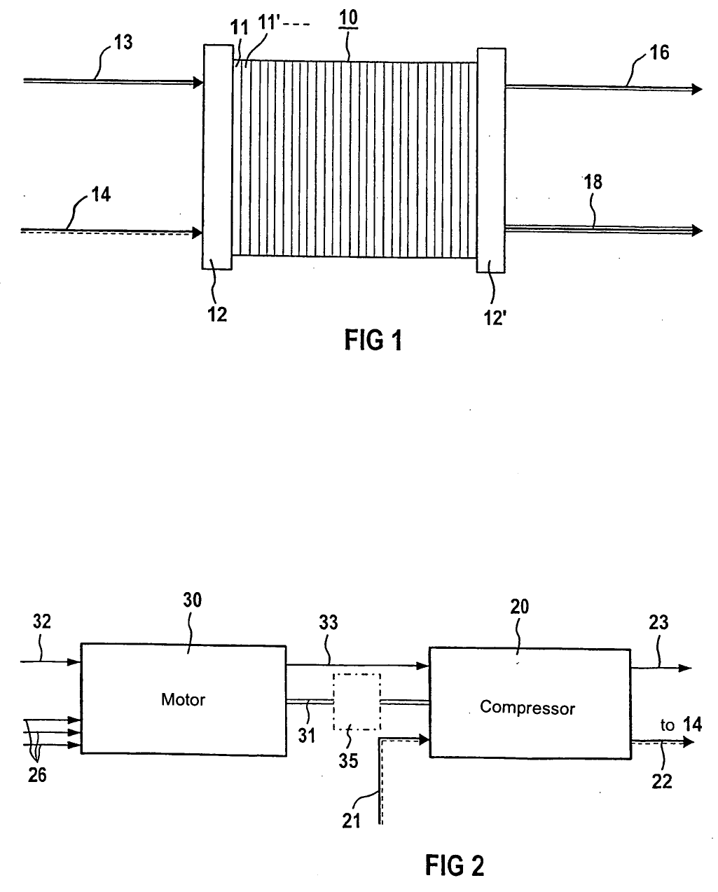

Referring now to the figures of the drawing in detail and first, particularly, to FIG. 1 thereof, there is shown a fuel cell module 10 which contains a plurality of stacked PEM fuel cells 11, 11′, . . . with end plates 12, 12′. A fuel cell stack of this type is also known in the specialist field as just stack for short. To operate the fuel cell module 10, hydrogen is supplied as a fuel gas through a first line 13 and ambient air is supplied as an oxidizing agent through a second line 14. There are exit lines 16, 18 through which excess fuel and air, respectively, are discharged.

To provide a sufficient quantity of oxygen as the oxidizing agent for the fuel cell process from the ambient air, the air has to be compressed. To do this, it is known to use, inter alia, ring or screw-type compressors in particular. This also allows the introduction of liquid for humidification of the air. Specifically, a screw-type compressor with injection of liquid is known from German Patent DE 195 43 879 C2. The efficiency of this compressor is good, and the liquid is injected using simple measures.

In FIG. 2, a compressor 20 of this type, which is fed with ambient air through a line 21 and from which humidified air is discharged through a line 22 which is connected to the entry line 14 of the fuel cell module 10 from FIG. 1.

The compressor 20 is assigned an electric motor 30 with signal inputs 26. The electric motor 30 has a rotary axle 31, through which mechanical power is transmitted to the compressor 20. This can be realized by the motor axle 31 forming a common axle with the drive of the compressor 20, which is not illustrated in detail in FIG. 2.

As an alternative, or in addition, there may be a transmission 35, which is only indicated in FIG. 2. By way of example, a gearwheel transmission is suitable for this purpose.

The electric motor 30 has to be cooled. For this purpose, there is a cooling-water line 32 on the entry side. The cooling water for the electric motor 30 is discharged from the motor 20 via a cooling-water exit line 33, with the line 33 simultaneously serving as an entry line for the compressor 20. As a result, therefore, the cooling water that has been heated by operation of the motor is simultaneously used as humidification water for the compressor 20. The humidification water, after it has been cooled, is discharged from the compressor 20 via a line 23.

In the configuration shown in FIG. 2, therefore, the water is used to cool the motor 30 of the compressor 20 before it is injected into the compressor 20. Suitable construction of the motor winding allows the uptake of heat by the water, given a suitable selection of the pressure in the cooling-water line 30, to be enough to take up the evaporation enthalpy for sufficient humidification of the air in the compressor 20. It is therefore also possible to perform separate cooling of the compressor 20.

The winding of the motor 30 may be constructed in a suitable way, such that the winding temperature, as a result of the use of a Teflon insulation, reaches temperatures of higher than 100° C. At a temperature of this nature, the uptake of heat by the water, given a suitable selection of the pressure, is sufficient to achieve optimum heat transfer. It is advantageous to configure the cooling-water line 32 as a copper tube and for it to be used directly as coil material for the motor 30. In this case, the coil may be provided with alternating windings of solid material and tube material.

The principle that has been expounded in detail above on the basis of a fuel cell stack with PEM fuel cells can also be transferred to other fuel cell modules. By way of example in solid oxide fuel cell (SOFC) systems, which operate with a ceramic electrolyte and with standard fuel gas at high temperatures, the oxidizing agent used is likewise atmospheric oxygen, and for this purpose ambient air is prepared by suitable compressors. In this case, the compressed air and, if appropriate, also the fuel gas are likewise humidified, so that in this respect the same relationships as for a polymer electrolyte membrane (PEM) fuel cell result.

The solution to the problem illustrated in FIGS. 1 and 2 can therefore be used in a corresponding way for SOFC fuel cell systems as well.

With the structure described, the utilization of the waste heat from the motor winding can be used not only to evaporate the water but also for other applications. Further motor windings, for example those of a traction motor in a motor vehicle, are suitable for this purpose, provided that a PEM fuel cell system is specifically configured for mobile use.

However, motor windings of pumps in a stationary SOFC fuel cell system or similar configurations can also be used in the context of the invention.

We claim:

1. A method for operating a fuel cell system with a fuel gas and an oxidizing agent, which comprises the steps of:
sufficiently humidifying the fuel gas and/or the oxidizing agent by evaporating humidification water; and
utilizing heat generated by a winding temperature of an electric motor used to deliver gases as an energy source for evaporating the humidification water to humidify the fuel gas and/or the oxidizing agent.

2. The method according to claim 1, which further comprises utilizing at least one gas selected from the group consisting of hydrogen, hydrogen-rich methane and reformate as the fuel gas.

3. The method according to claim 1, which further comprises compressing air using a compressor until a suitable quantity of oxygen is present as the oxidizing agent.

4. The method according to claim 3, which further comprises routing the humidification water in a cooling-water line of the compressor having a compressor motor, and generating the heat required for evaporating the humidification water in the compressor motor.

5. The method according to claim 4, which further comprises setting a pressure for ensuring that an uptake of the heat by the humidification water in the cooling-water line is kept at a sufficiently high level for evaporation enthalpy resulting in sufficient humidification of the air to be taken up.

6. The method according to claim 3, which further comprises using the humidification water also as cooling water for the compressor.

7. The method according to claim 6, which further comprises injecting the humidification water into the compressor having a compressor motor for cooling the compressor motor before the humidification water is injected into the compressor.

8. The method according to claim 1, which further comprises:
utilizing the fuel cell in a motor vehicle having a traction motor; and
utilizing waste heat from the traction motor to provide evaporation heat for the humidification water to humidify the fuel gas and/or the oxidizing agent.

9. A fuel cell system, comprising:
at least one fuel cell module operated with a fuel gas and air as an oxidizing agent;
a compressor for compressing the air supplied to said fuel cell module;
an electric motor driving said compressor, said electric motor having a device for cooling said electric motor with cooling water; and
an exit line connected between said electric motor and said compressor, the cooling water emerging from said electric motor being fed though said exit line to said compressor as humidification water.

10. The fuel cell system according to claim 9, wherein said compressor and said electric motor for driving said compressor have a common axle, with mechanical power transmission from said electric motor to said compressor being transmitted through said common axle.

11. The fuel cell system according to claim 9 further comprising a transmission for power transmission between said electric motor and said compressor.

12. The fuel cell system according to claim 9, wherein said electric motor has windings formed from tubes with water flowing through them.

13. The fuel cell system according to claim 9, wherein said compressor is an air compressor being a screw-type compressor.

14. The fuel cell system according to claim 9, wherein said fuel cell module includes polymer electrolyte membrane fuel cells.

15. The fuel cell system according to claim 9, wherein said fuel cell module includes solid oxide fuel cells.
